(19) United States
(12) Patent Application Publication
(10) Pub. No.: US 2025/0057113 A1
(43) Pub. Date: Feb. 20, 2025

(54) ANIMAL FEEDING APPARATUS

(71) Applicant: Lafayette Bay Products LLC, Orono, MN (US)

(72) Inventor: Phillip Ward Myers, JR., Wayzata, MN (US)

(21) Appl. No.: 18/805,330

(22) Filed: Aug. 14, 2024

Related U.S. Application Data
(60) Provisional application No. 63/519,726, filed on Aug. 15, 2023.

(51) Int. Cl. A01K 5/01

(52) U.S. Cl. CPC A01K 5/0114

(57) ABSTRACT

An animal feeding apparatus comprising a first bowl, the first bowl comprising a first locking structure. An animal feeding apparatus can further comprise an annular adapter comprising a second locking structure configured to couple to the first locking structure, and the adapter can additionally comprise a third locking structure configured to couple to a container. The bowl can be configured to be seated in a central opening of the adapter when the first locking structure is coupled to the second locking structure.

### CROSS-REFERENCE TO RELATED APPLICATIONS

This application claims the benefit of priority to U.S. Provisional Patent Application No. 63/519,726, filed Aug. 15, 2023, the contents of which is incorporated by reference herein in its entirety.

### BACKGROUND

Some people provide food for consumption by animals, such as domesticated animals. Animal food can be provided in a feeding vessel.

### SUMMARY

Embodiments disclosed herein can relate to an animal feeding apparatus comprising a first bowl, the first bowl comprising a first locking structure. An animal feeding apparatus can further comprise an annular adapter comprising a second locking structure configured to couple to the first locking structure, and the adapter can additionally comprise a third locking structure configured to couple to a container. The bowl can be configured to be seated in a central opening of the adapter when the first locking structure is coupled to the second locking structure.

In some embodiments, the container can be a bucket. In some embodiments, the bucket is a 5-gallon bucket. In some embodiments, the first locking structure and the second locking structure form a snap fit mechanism. In some embodiments, the first locking structure and the second locking structure form an interlocking twist fit mechanism. In some embodiments, the first locking structure comprises a tab and the second locking structure comprises a slot configured to receive the tab. In some embodiments, the third locking structure forms a snap fit mechanism. In some embodiments, the bowl is a slow feed bowl.

Embodiments disclosed herein can relate to an animal feeding apparatus comprising an adapter comprising a plurality of outer tabs disposed on a circumference of the adapter and a plurality of slots disposed on an inner circumference of the adapter. An animal feeding apparatus can further comprise a bowl comprising a plurality of tabs disposed on a circumference of the bowl, where the plurality of tabs of the bowl can be configured to interlock with the slots of the adapter to couple the adapter and the bowl. The outer tabs of the adapter can be configured to couple to a bucket.

In some embodiments, the tabs of the adapter are configured to couple to a 5-gallon bucket. In some embodiments, the outer tabs are configured to couple with the bucket as a snap fit. In some embodiments, the tabs of the bowl are configured to interlock with the plurality of slots of the adapter to couple the adapter and the bowl by rotating the bowl relative to the adapter. In some embodiments, the bowl further comprises protrusions for applying a twisting force. In some embodiments, the bowl is a slow-feed bowl.

Embodiments disclosed herein can relate to an animal feeding system comprising a bucket having a rim and a bowl seated inside the rim of the bucket, wherein the bowl is a slow-feed bowl.

In some embodiments, the bucket is a 5-gallon bucket. In some embodiments, the system further comprises an adapter having an outer circumference configured to couple to the rim and an inner circumference configured to couple to the bowl. In some embodiments, the bowl is configured to couple to the adapter using an interlocking twist fit. In some embodiments, the bowl comprises a plurality of first tabs disposed on a circumference of the bowl and the adapter comprise a plurality of slots disposed on an inner circumference of the adapter. In some embodiments, the adapter is configured to couple to the rim using a snap fit.

### BRIEF DESCRIPTION OF THE DRAWINGS

FIG. 1 is an exploded view of an animal feeding apparatus in accordance with the various embodiments disclosed herein.

FIG. 2 is a perspective view of an animal feeding apparatus in accordance with the various embodiments disclosed herein.

FIG. 3 is a cutaway view of an animal feeding apparatus in accordance with the various embodiments disclosed herein.

FIG. 4 is a cutaway view of an animal feeding apparatus in accordance with the various embodiments disclosed herein.

FIGS. 5A-5C depict the components of an animal feeding apparatus in accordance with the various embodiments disclosed herein.

FIGS. 6A-6B depict an animal feeding apparatus in accordance with the various embodiments disclosed herein.

FIGS. 7A-7B depict the bowl and adapter of an animal feeding apparatus in accordance with the various embodiments disclosed herein.

FIGS. 8A-8C depict an animal feeding apparatus in a first configuration in accordance with the various embodiments disclosed herein.

FIGS. 9A-9C depict an animal feeding apparatus in a first configuration in accordance with the various embodiments disclosed herein.

FIG. 10 depicts a cutaway view of an animal feeding apparatus in accordance with the various embodiments disclosed herein.

FIGS. 11A-11C depict an animal feeding apparatus in accordance with the various embodiments disclosed herein.

FIGS. 12A-12B depict an animal feeding apparatus in accordance with the various embodiments disclosed herein.

FIGS. 13A-13B depict cutaway views of an animal feeding apparatus in accordance with the various embodiments disclosed herein.

### DESCRIPTION

Embodiments described herein provide for a multi-component animal feeding apparatus that provides for multiple feeding methods including slow feeding, regular feeding, elevated feeding, while also providing for storage. The apparatus described herein generally comprise a bowl and an adapter, the bowl configured to couple to the adapter and the adapter configured to couple to a bucket. In this way, different bowls (e.g., water bowls, regular feeder bowls, slow feeder bowls, etc.) can be interchanged for use with a feeder adapter, the feeder adapter configured attach to a bucket that can be used to, for example, store animal food. The adapters described herein can be configured to couple to standard buckets such as 5-gallon buckets, 3-gallon buckets, 2-gallon buckets, and the like.

The adapters described herein can connect to a bucket by, for example, a snap fit. The bowls described herein can be configured to connect to the adapters by a snap fit, a twist fit, or another connection design. By way of example, flexible tabs on a bowl can be designed to flex when pushed into the adapter and snap into place, thereby retaining the bowl. Alternatively, an interlocking bowl can have tabs and slots designed so that the bowl can be lowered onto an adapter with offset tabs and slots so that the bowl can be twisted into position, thereby securing it to the adapter.

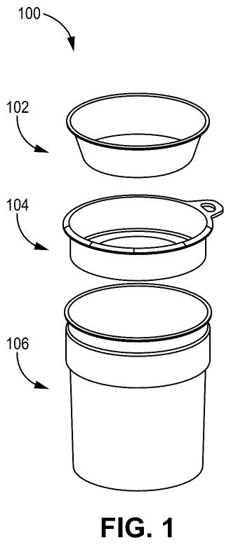

FIG. 1 shows an exploded view of an animal feeder apparatus 100 in accordance with the various embodiments described herein. The apparatus 100 includes a bowl 102. The bowl 102 can be designed to hold a quantity of animal food for use in a feeding session. For example, the bowl 102 could have a volume sufficient to hold an amount of dog food required for a single meal or feeding session. The apparatus 100 includes an adapter 104. The apparatus 100 also includes a bucket 106. The adapter 104 is configured to couple with the bucket 106, as will be described further below. The bowl 102 is configured to couple with the adapter 104, as will be described further below. The adapter 104 can have ribs for increasing its strength and rigidity.

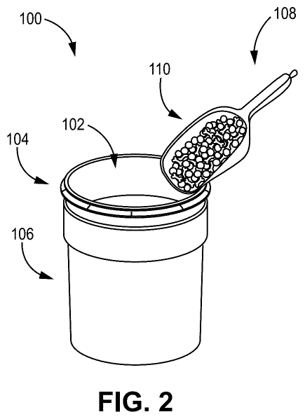

FIG. 2 depicts the apparatus 100 of FIG. 2 in an assembled configuration. That is, the bowl 102 is coupled to the adapter 104, which is coupled to the bucket 106. Also shown is a feed scoop 108 adding a quantity of animal feed 110 to the bowl 104.

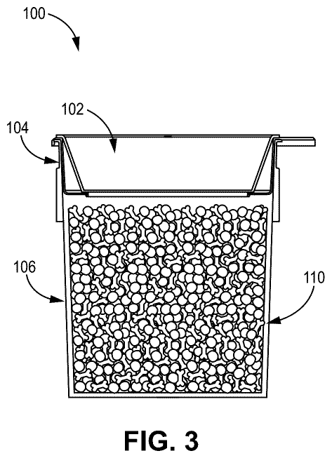

FIG. 3 depicts a cutaway view of the apparatus 100 of FIG. 1 in an assembled configuration. That is, the bowl 102 is coupled to the adapter 104, which is coupled to the bucket 106. Also shown is animal feed 110 stored inside of the bucket 110. The animal feed 110 can be dog food, dog treats, other animal feed, or other non-food objects or materials such as dog toys.

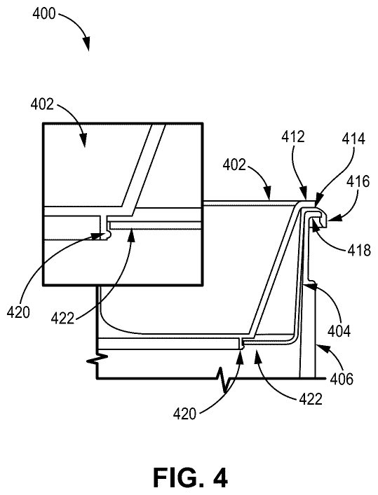

FIG. 4 shows a partial cutaway view of an animal feeder apparatus 400 consistent with the embodiments disclosed herein. The apparatus 400 includes a feeder bowl 402, an adapter 404, and a bucket 406. The apparatus 400 is configured as a snap-fit apparatus. The adapter 404 has one or more tabs 416. The tabs 416 of the adapter 404 are distributed around a circumference of the adapter 404. The adapter 404 can be pushed onto a bucket and snapped into place. Specifically, tabs 416 of the adapter 404 are configured to flex and snap into position on a bucket rim 418 of the bucket 406. When in position, a rim edge 414 of the adapter 404 is held against the bucket rim 418 of the bucket 406 by the tabs 416. When in a coupled configuration, the tabs 416 of the adapter 404 can be configured to be deformed such that a bias force on the tabs 416 holds the tabs 416 tightly against the bucket rim 418, thereby securing the adapter 404 to the bucket 406. The interface between the bucket rim 418 of the bucket 406 and the rim edge 414 of the adapter 404 can form a substantially airtight seal.

The bowl 402 and the adapter 404 can also be configured to couple using a snap fit mechanism. The bowl 402 can have one or more tabs 420. The tabs 420 of the bowl 402 are distributed around a circumference of the bowl. The tabs 420 of the bowl 402 can be configured to flex and snap into position on an edge 422 of the adapter 404. When in a coupled position, the tabs 420 of the bowl 402 can be configured to be deformed such that a bias force on the tabs 420 holds the tabs 420 tightly against the edge 422 of the adapter 404, thereby securing the bowl 406 to the adapter 404. The interface between a bowl rim 412 of the bowl 402 and a rim surface 414 of the adapter 404 can form a substantially airtight seal.

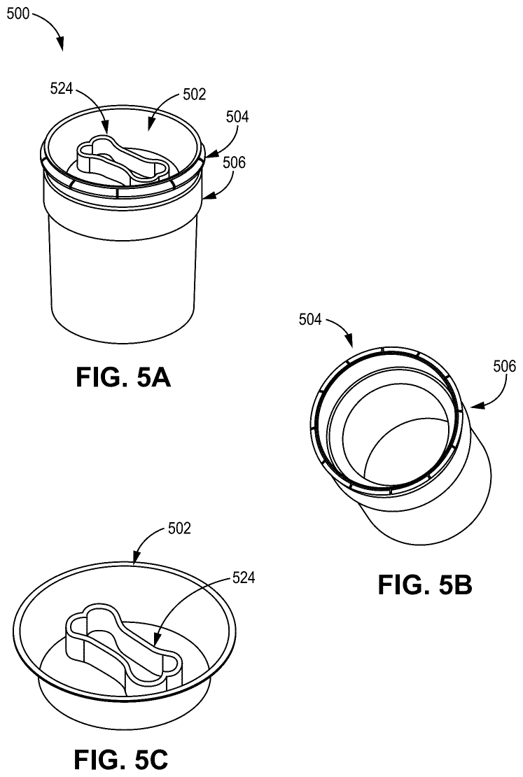

By providing a separate bowl and adapter, the apparatuses described herein are modular. A single adapter used to fit a particular type of bucket, such as a 5-gallon or 2-gallon bucket, can be used to accommodate different types of bowls, such as regular bowls, slow-feeder bowls, or water bowls, or other known animal feeding bowls. FIG. 5A depicts an apparatus consistent with those described with reference to FIGS. 1-4 but having a slow-feeder bowl. The apparatus 500 has a bowl 502, an adapter 504, and a bucket 506. FIG. 5B depicts the system 500 with the bowl removed so that the inside of the adapter 504 and bucket 506 can be seen. FIG. 5C shows the slow-feeder bowl 502. The slow-feeder bowl 502 contains baffles 524. The baffles 524 are configured to interfere with an animal feeding from the bowl, thereby slowing the rate at which the animal can access and cat the food in the bowl 502. The baffles 524 are shown to have the shape of a bone, but other shapes are possible and are not particularly limited so long as they sufficiently impede the feeding process.

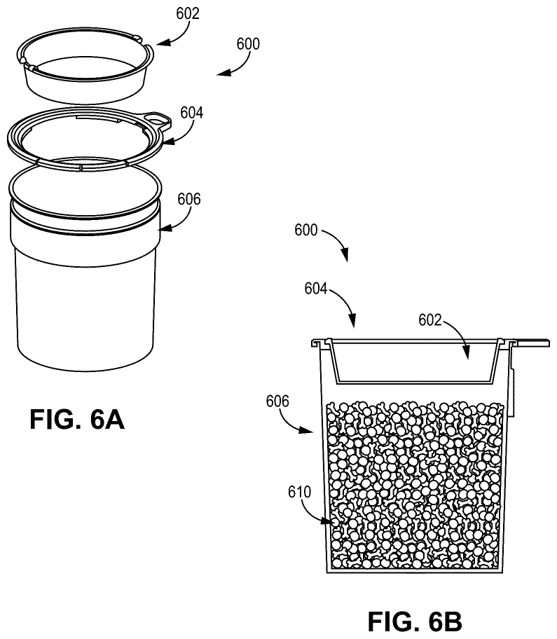

FIG. 6A is an exploded view of an animal feeding apparatus 600 configured as an interlocking twist-fit apparatus. The feeding apparatus 600 includes a feeder bowl 602, an adapter 604, and a bucket 606. FIG. 6B is a cutaway view of the feeding apparatus 600 in an assembled configuration. That is, the bowl 602 is coupled to the adapter 604, which is coupled to the bucket 606. Also shown is animal feed 610 stored inside of the bucket 610. The animal feed 610 can be dog food, dog treats, other animal feed, or other non-food objects or materials such as dog toys.

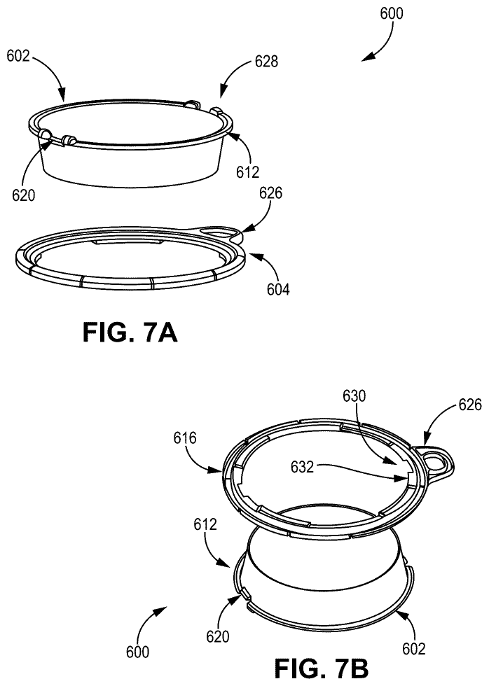

FIGS. 7A and 7B show top and bottom perspective exploded views of the bowl 602 and adapter 604 of the apparatus 600 of FIGS. 6A-6B. The adapter 604 is configured to snap fit onto a bucket 606 consistent with the snap fit designs discussed with reference to FIG. 4. The bowl 602 and adapter 604 are configured to couple using an interlocking twist fit design, which will be described further below. The bowl 602 has an outer rim 612, outer tabs 620, and finger bumps 628. The adapter 604 has a loop 626, which can be used for manipulation by a user or for hanging the rim 604 when not in use. The adapter 604 also has outer tabs 616, an inner rim 632, and slots 630.

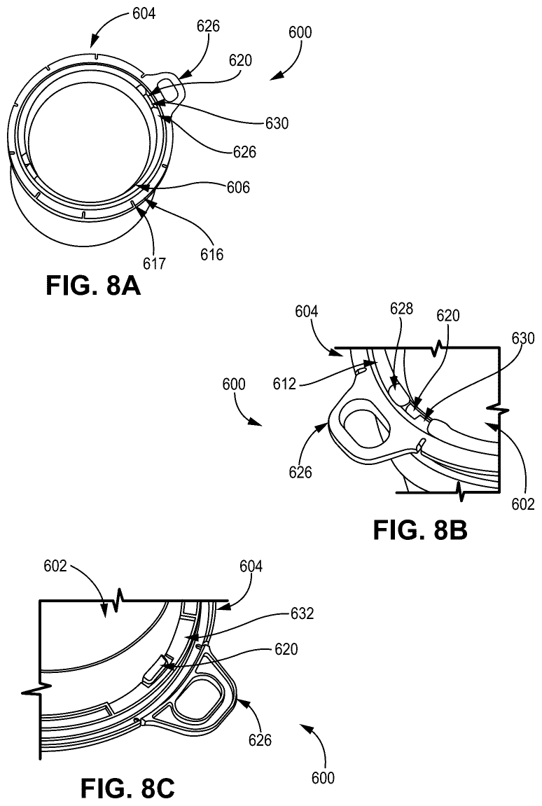

FIGS. 8A-8C show the apparatus 600 in an assembled, unlatched configuration. FIG. 8A shows the bowl 602 sitting in the adapter 604, which itself sits on the bucket 606. The outer tabs 616 of the adapter 604 are distributed along the circumference of the adapter 604, and are separated by notches 617. The outer tabs 616 act to form a snap fit with a rim of the bucket 606 consistent with the design discussed above with reference to FIG. 4. As is shown in FIGS. 8B and 8C, the bowl 602 is configured to be lowered onto the adapter 604 such that each outer tab 620 of the bowl 602 aligns with a respective slot 630 on the adapter 604. From this unlatched position, the bowl 602 can be rotated into a latched position, which will be described below. The finger bumps 628 are protrusions that can be pushed on by a user to rotate the bowl into a latched position.

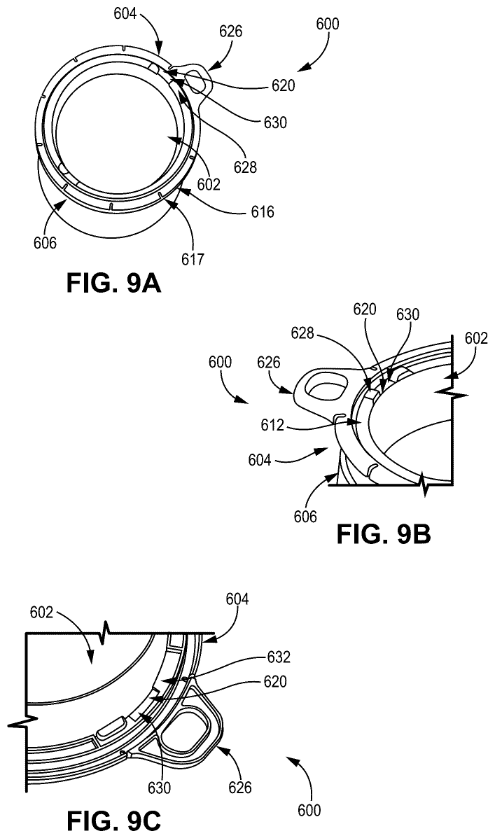

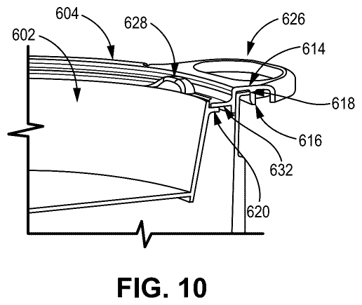

FIGS. 9A-9C show the apparatus 600 in an assembled, latched configuration. Relative to the configuration shown in FIGS. 8A-8C, the bowl has been rotated counterclockwise, when viewed from above, so that the outer tabs 620 of the bowl 602 engage with the inner rim 632 of the adapter 604. In some embodiments, the bowl 602 can also be rotated clockwise to lock it into position with the adapter 604. The inner rim 632 of the adapter 604 is pinched between the outer tabs 620 of the bowl 602 and the outer rim 612 of the bowl 620, thereby holding the bowl in place and forming a seal, which is shown in FIG. 10. The adapter 604 has one or more ridges 640 that act as positive locks. That is, the ridges 640 interfere with the outer tabs 620 of the bowl 602 and limit the amount which the bowl 602 can be rotated with respect to the adapter 604. Then the outer tabs 620 of the bowl 602 hit the ridges 640, the bowl 602 is in a fully locked position with respect to the adapter 604.

FIG. 10 shows a cutaway view of the apparatus 600 of FIGS. 6A-6B. The adapter 604 is configured to connect with the bucket 606 as a snap-fit apparatus. The adapter 604 has one or more tabs 616. The tabs 616 of the adapter 604 are distributed around a circumference of the adapter 604. The adapter 604 can be pushed onto a bucket and snapped into place. Specifically, tabs 616 of the adapter 604 are configured to flex and snap into position on a bucket rim 618 of the bucket 606. When in position, a rim edge 614 of the adapter 604 is held against the bucket rim 618 of the bucket 606 by the tabs 616. When in a coupled configuration, the tabs 616 of the adapter 604 can be configured to be deformed such that a bias force on the tabs 616 holds the tabs 616 tightly against the bucket rim 618, thereby securing the adapter 604 to the bucket 606. The interface between the bucket rim 618 of the bucket 606 and the rim edge 614 of the adapter 604 can form a substantially airtight seal.

In the latched configuration, the inner rim 632 of the adapter 604 is pinched between the outer tabs 620 of the bowl 602 and the outer rim 612 of the bowl 602, thereby holding the bowl in place and forming a seal, which is shown in FIG. 10. The outer tabs 620 of the bowl 602 can be angled slightly relative to horizontal such that they form a tighter pinch with the inner rim 632 of the adapter 604 and the outer rim 612 of the bowl the further the bowl 602 is rotated with respect to the adapter 604. The desired amount of pinching can be reached when the outer tabs 620 of the bowl 602 hit the ridges 640, and the bowl 602 is in a fully locked position with respect to the adapter 604.

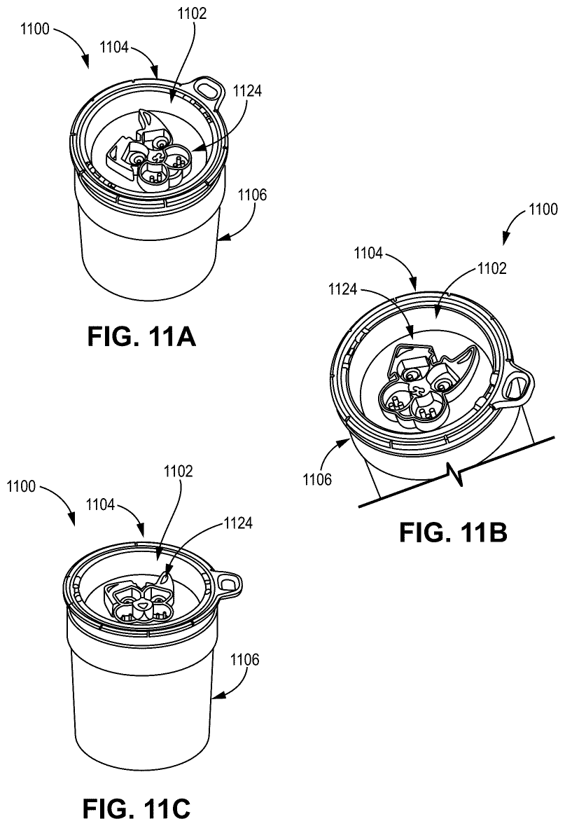

FIGS. 11A-11C show a feeding apparatus 1100 consistent with the feeding apparatuses described herein. The feeding apparatus 1100 is specifically configured as a twist-fit apparatus, as described above with reference to FIGS. 6A-10. The feeding apparatus 1100 has a bowl 1102, an adapter 1104, and a bucket 1106. The bowl 1102 is configured as a slow-feeder bowl and has baffles 1124. The baffles 1124 are shown to have the shape of a dog's face, but other shapes are possible and are not particularly limited so long as they sufficiently impede the feeding process.

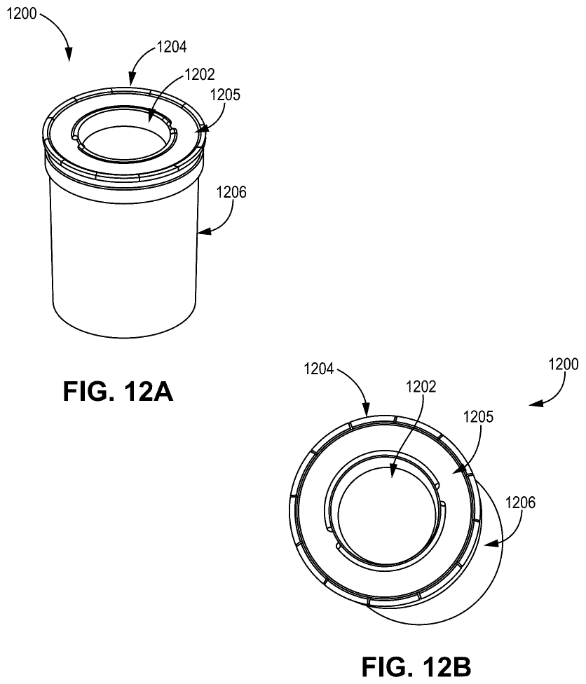

The embodiments shown in the preceding figures have depicted feeding apparatuses on a smaller bucket with a diameter not significantly larger than the diameter of the bowl. For example, these embodiments could represent apparatuses using smaller buckets such as 2- or 3-gallon buckets. However, the volume of the buckets that can be used with the adapters and bowls disclosed herein are not so limited, and can include larger or smaller buckets. For example, the adapters and bowls disclosed herein can be configured to be positioned on 5-gallon buckets, such as those that are commonly sold at hardware stores. FIGS. 12A-12B depict a feeding apparatus 1200 consistent with the various embodiments disclosed herein that use a larger bucket, such as a 5-gallon bucket. The apparatus 1200 includes a bowl 1202, an adapter 1204, and a bucket 1206. The bowl 1202 and the adapter 1204 are configured to couple using a twist fit, as described above with reference to FIGS. 6A-10. The adapter 1204 is configured to couple with the bucket 1206 using a snap fit, as described above with reference to FIGS. 4 and 10. On the apparatus 1200, the adapter 1204 has a sidewall 1205 between an outer circumference of the adapter and an inner circumference of the adapter where the bowl 1202 is seated. The sidewall 1205 is sized so that a standard bowl can be used on different bucket sizes. In other words, the adapter 1204 can be one of many different sizes and configurations of adapters that are configured to fit particular styles and sizes of buckets while all bowls for use in those different buckets can be the same. For example, the same bowl can be used on a 2-gallon, 3-gallon, or 5-gallon bucket so long as an appropriately-sized adapter is used for that particular bucket size.

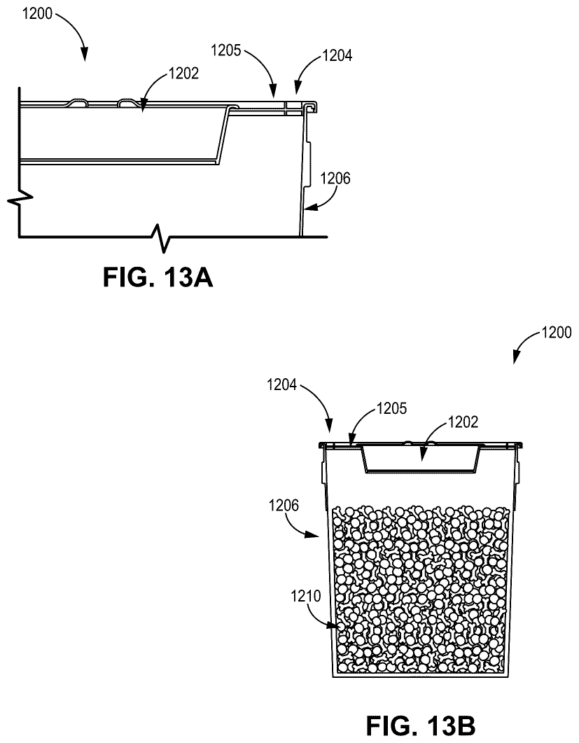

FIG. 13A shows a cutaway view of the apparatus 1200. FIG. 13B shows a cutaway view of the apparatus 1200 with animal feed 1210 stored inside the bucket 1206.

The animal feeding apparatuses disclosed herein can be configured and used to feed different type of animals. For example, the apparatuses can be configured to feed dogs. In other embodiments, the apparatuses can be configured to feed domestic or wild animals including cats, goats, deer, donkeys, sheep, chickens, turkeys, or any other animal.

The bowls configured for use in the feeding apparatuses disclosed herein can have any configuration known or useful for feeding animals. For example, the bowls can include regular feeder bowls, water bowls, slow feeder bowls, or any other bowl that can be configured to have the connecting structures so that it will connect with the adapters disclosed herein. Bowls having different volumes and dimensions can be used to accommodate different animals.

The buckets used with the feeding apparatuses disclosed herein are not particularly limited, and can include standard 5-gallon buckets, 3-gallon buckets, 2-gallon buckets, and the like, which are sometimes also referred to as “pails.” The buckets used on the apparatuses disclosed herein are not limited to a particular shape, such as cylindrical. Buckets having square, rectangular, or any other cross section can be used with an accordingly configured adapter. The buckets used in the apparatuses disclosed herein are generally configured to hold animal feed, such as dog food and/or treats. The buckets used can be sized according to a desired feed height and feed storage volume for different animals. The buckets used herein can include any type of storage vessel. The adapters used herein can be sized to adapt suitable bowls to suitable buckets according to the needs of the particular use case, and are generally designed to fit a particular style of bucket and use interchangeable bowls.

The materials used to construct the components of the feeding apparatuses disclosed herein are not limited. Exemplary materials can include HDPE, PMMA, PC, PE, PP, PET, PVC, ABS, or any other plastic material. In some embodiments, one or more of the components of the apparatuses disclosed herein are made from recycled plastic, such as recycled plastic bottles. Other materials such as metals can be used.

What is claimed:

1. An animal feeding apparatus comprising:
a bowl comprising a first locking structure; and
an annular adapter comprising a second locking structure configured to couple to the first locking structure, the adapter further comprising a third locking structure configured to couple to a container;
wherein the bowl is configured to be seated in a central opening of the adapter when the first locking structure is coupled to the second locking structure.

2. The apparatus of claim 1, wherein the container is a bucket.

3. The apparatus of claim 2, wherein the bucket is a 5-gallon bucket.

4. The apparatus of claim 1, wherein the first locking structure and the second locking structure form a snap fit mechanism.

5. The apparatus of claim 1, wherein the first locking structure and the second locking structure form an interlocking twist fit mechanism.

6. The apparatus of claim 5, wherein the first locking structure comprises a tab and the second locking structure comprises a slot configured to receive the tab.

7. The apparatus of claim 1, wherein the third locking structure forms a snap fit mechanism.

8. The apparatus of claim 1, wherein the bowl is a slow-feed bowl.

9. An animal feeding apparatus comprising:
an adapter comprising a plurality of outer tabs disposed on a circumference of the adapter and a plurality of slots disposed on an inner circumference of the adapter;
a bowl comprising a plurality of tabs disposed on a circumference of the bowl;
wherein the plurality of tabs of the bowl are configured to interlock with the slots of the adapter to couple the adapter and the bowl; and
wherein the outer tabs of the adapter are configured to couple to a bucket.

10. The apparatus of claim 9, wherein the outer tabs of the adapter are configured to couple to a 5-gallon bucket.

11. The apparatus of claim 9, wherein the outer tabs are configured to couple with the bucket as a snap fit.

12. The apparatus of claim 9, wherein the plurality of tabs of the bowl are configured to interlock with the plurality of slots of the adapter to couple the adapter and the bowl by rotating the bowl relative to the adapter.

13. The apparatus of claim 12, wherein the bowl further comprises protrusions for applying a twisting force.

14. The apparatus of claim 9, wherein the bowl is a slow-feed bowl.

15. An animal feeding system comprising:
a bucket having a rim; and
a bowl seated inside the rim of the bucket; wherein the bowl is a slow-feed bowl.

16. The system of claim 15, wherein the bucket is a 5-gallon bucket.

17. The system of claim 15, further comprising an adapter having an outer circumference configured to couple to the rim and an inner circumference configured to couple to the bowl.

18. The system of claim 17, wherein the bowl is configured to couple to the adapter using an interlocking twist fit.

19. The system of claim 18, wherein the bowl comprises a plurality of tabs disposed on a circumference of the bowl and the adapter comprises a plurality of slots disposed on an inner circumference of the adapter.

20. The system of claim 17, wherein the adapter is configured to couple to the rim using a snap fit.
